(19) United States
(12) Patent Application Publication
(10) Pub. No.: US 2026/0058410 A1
(43) Pub. Date: Feb. 26, 2026

(54) ELECTRICAL CONNECTOR WITH REDUCED SKEW

(71) Applicant: Aptiv Technologies AG, Schaffhausen (CH)

(72) Inventors: Thomas BENEKEN, Schalksmühle (DE); Yushan CHEN, Wuppertal (DE); Gert DROESBEKE, Erkrath (DE); Rajesh PALANISWAMY, Tamil Nadu (IN); Thomas REINDERS, Wuppertal (DE)

(21) Appl. No.: 19/305,940

(22) Filed: Aug. 21, 2025

(30) Foreign Application Priority Data
Aug. 21, 2024 (EP) 24195525.1

(51) Int. Cl. H01R 13/646; H01R 12/72

(52) U.S. Cl. CPC H01R 13/646; H01R 12/722; H01R 2201/26

(57) ABSTRACT

An electrical connector includes two or more mutually electrically insulated conductors, a first conductor longer than a second conductor, and at least one insulating element arranged between the first and second conductors and/or around at least one conductor. A portion of the insulating element provides lower permittivity and/or permeability for the first conductor and higher permittivity and/or permeability for the second conductor. The permittivity and/or permeability difference between the conductors is configured to compensate for the conductor length difference so as to essentially minimize the difference in signal delay between the conductors.

### CROSS-REFERENCE TO RELATED APPLICATION

This application claims the benefit of and priority to European Application No. 24195525.1 filed with the European Patent Office on Aug. 21, 2024, the contents of which are incorporated by reference herein.

### TECHNICAL FIELD

The present disclosure relates to an electrical connector with reduced skew, particularly for automotive applications.

### BACKGROUND

Transmission of electrical signals is subject to distortion and imbalanced delays from imperfections of the signal path and electric noise from the environment. One way to improve the quality of electrical signal transmissions is to make use of structural associations of a plurality of mutually insulated electrically conductive connecting elements (in short: conductors) with well-designed mutual electro-magnetic couplings between said conductors.

Known configurations include two or more mutually coupled conductors, for instance but not limited to pairs, triples, or quads. A problem that occurs when electrical signals propagate through two or more conductors is skew, which is a difference in propagation speed between the conductors. Skewing can be caused by different geometric lengths of the signal conductors such that due to the finite signal propagation speed the signal in the shorter conductor reaches the end of the conductor faster than a signal in the longer conductor.

Skewing can have an impact on signal integrity. For example, a portion of a differential signal may be transferred into a common mode signal (so called mode conversion) which may contribute to jitter and can impair signal detection. Skew can also have a negative impact on electromagnetic compatibility (EMC) due to worse coupling attenuation which is a measure for the symmetry of the signal propagation and the quality of the shield.

Skewing can generally occur between different lanes, i.e., when a data stream is split into various paths (inter-pair skew). It also occurs as a difference in signal propagation time between different conductors of a signal pair, triple, etc. (intra-pair skew).

Thus, it is advantageous to adjust the signal propagation times on all associated conductors along the signal path. Under certain circumstances, e.g., if the signal path has a curvature in such way that the geometrical length of one conductor in a bundle of associated conductors is different from the length of one or more of the other conductors, the quality of the signal transmission will be impaired, especially with higher data rates, as outlined.

One way to compensate for skewing is to introduce a so-called opposite turn which introduces an offset to the shorter conductors by a right-turn and an opposing left-turn. However, this solution requires additional space and is only applicable if no bend of the conductors is required. It also has a limited application as it is dependent on frequency and the length of the conductors. Another solution is to add some extra length to the shorter conductors. However, this introduces other issues such as impedance mismatches.

Yet a further solution is a complex three-dimensional geometry of the conductors to avoid conductor length differences, i.e., the conductors follow a well-designed three-dimensional path such that all conductors essentially have the same geometrical length. However, this solution consumes a lot of additional space. In addition, it may create additional geometrical constraints on one or both ends of the connector, e.g., by limiting the position of the conductor's terminals on a printed circuit board (PCB).

It is therefore the object of this disclosure to provide an electrical connector with two or more electrical conductors which minimizes skew, and which avoids the disadvantages of the prior art.

### SUMMARY

The above objectives are at least partially met by an electrical described herein. Thus, the electrical connector includes two or more electrical conductors. The conductors are mutually electrically insulated. The first of the at two or more conductors is longer than the second of the two or more conductors. The electrical connector also includes at least one insulating element arranged between the first and the second conductor and/or around at least one of the first or the second conductor. At least a portion of the insulating element causes a smaller permittivity and/or permeability for the first conductor and a higher permittivity and/or permeability for the second conductor. A difference of permittivity and/or permeability between the first and second conductor is configured such that a difference in signal delay between the first and the second conductor is essentially minimized.

Any skew due to geometric length differences between the conductors is compensated for by a difference in permittivity and/or permeability at the respective conductors. The difference in permittivity and/or permeability is adjusted by configuring an insulating element accordingly. Therefore, the electrical connector avoids the disadvantages of the prior art because no modification of the conductors is necessary to minimize skew. Rather, the conductors can be formed according to other requirements and constraints such as space requirements, terminal positions at a PCB, etc.

Generally, the permittivity is the ability of a dielectric material to store electrical energy in an electric field. Permeability is a measure of magnetization produced in a material in response to an applied magnetic field. In the context of the present disclosure, the permittivity may be an effective permittivity. The effective permittivity is measured in a non-homogeneous material (a mixture of different materials having different relative permittivity). So, the effective permittivity is an average of the individual relative permittivity for the entire configuration of materials. The effective permittivity may also depend on the geometry of the materials in the vicinity of the electrical conductor and the distribution field. “Material” in the context of the present disclosure also includes gas (such as air) or liquids. Similar considerations apply for the effective permeability and the magnetic field.

“Essentially minimized” with respect to the signal delay in the context of the present disclosure means that the resulting signal delay is smaller compared to a connector having an insulating element which is not configured for an adaption of permittivity and/or permeability at a particular conductor or compared to the raw signal delay that is to be expected due to the pure geometric difference in length of the conductors.

The first and second conductors may be curved causing a difference in length between both conductors. Curved or bent conductors may be necessary, for example in case of a connector having a terminal interface at a 90° angle relative to a PCB. If some of the conductors are vertically staggered at the terminal interface, the electrical connector advantageously helps to compensate for length differences between the conductors.

The insulating element may include at least one air pocket causing the lower permittivity for the first conductor. Air pockets are an effective and lower cost method to reduce the permittivity. In fact, air has the lowest possible permittivity (except for a vacuum). Therefore, an air pocket in the insulating element effectively lowers the permittivity. In addition, air pockets can easily be integrated in the insulating element, for example by way of molding the insulating element as explained above. Contrary, the relative permeability (i.e., the magnetization produced in a material as response to an applied magnetic field) of most insulation materials is unity, i.e., the same as air. Therefore, the use of air pockets is applicable to decrease the permittivity rather than the permeability (unless special, magnetizable materials like composite polymers might be used).

The air pocket may be a recess or slot. For example, if the insulating element is molded, a recess or slot can be created by a complementary protrusion in a mold.

The air pocket may be arranged nearer to the first conductor than to the second conductor. In this way the lower permittivity and/or permeability for the first conductor can be caused.

The air pocket may be arranged such that a portion of the surface of the first conductor is exposed to air. In this way the lower permittivity and/or permeability for the first conductor can be caused. At the same time, a different portion of the surface of the first conductor may still be embedded in the insulating element. For example, in case of a conductor with a rectangular cross section, only one of the four lateral faces of the conductor might be exposed to air. Thus, the mechanical stability of the conductor is maintained while the permittivity and/or permeability at the conductor can be tailored to minimize skew. In an alternative configuration, a portion of the first conductor may be completely exposed. In the example of a conductor with a rectangular cross section, a section of the first conductor might have all four lateral faces exposed to air.

The insulating element may include at least one additive causing the higher permittivity and/or permeability for the second conductor. In this way, the permittivity and/or permeability can be increased to achieve a higher difference in permittivity and/or permeability between both conductors. Increasing the permittivity and/or permeability at the second conductor can be combined with lowering the permittivity and/or permeability at the first conductor as outlined above, e.g., by a recess, slot, or air pocket. Thus, even large differences in length of both conductors can be compensated.

The additive may be glass fibers and/or ceramic and/or pigments. Those additives are readily available and can easily be added for example in a mold process.

The density of the at least one additive may be essentially the same throughout the insulating element. Alternately, the density of the at least one additive may be higher in a proximity of the second conductor compared to the proximity of the first conductor. In this way, the permittivity and/or permeability is effectively increased at the second conductor to minimize skewing between both conductors. This may be combined with lowering permittivity and/or permeability at the first conductor as described herein.

The electrical connector may be an insert molded lead frame assembly (IMLA). An IMLA includes a plurality of electrical conductors, typically arranged as an array, in a lead frame housing.

The first conductor and the second conductor may form a differential pair, or the first conductor and the second conductor may form parallel lanes. As explained above, intra-pair skew may occur in a differential pair, whereas inter-pair skew may occur between parallel lanes. Both types of skew are detrimental to the performance of the connector. Therefore, the present invention can be advantageously applied to both types of skew.

The connector may be a data connector adapted for data transmission. Differences in propagation delay between different conductors of a connector become more detrimental at high frequencies which are typical for data transmission applications. Examples of such detrimental effects include jitter, signal waveform distortion, and EMC issues. Thus, the present invention advantageously overcomes or at least reduces such negative effects in data transmission applications.

### BRIEF DESCRIPTION OF THE DRAWINGS

Possible embodiments are described in more detail in the following detailed description with reference to the following figures.

FIG. 1 illustrates a cross-section side view of an electrical connector and shows how electrical skew may be caused by differences in length of two conductors.

FIG. 2 illustrates a side view of an electrical connector according to some embodiments.

FIGS. 3A to 3L illustrate different possibilities of guiding two conductors through a 90° turn and different types of skew compensation in an electrical connector according to some embodiments.

### DETAILED DESCRIPTION

For the sake of brevity, only a few embodiments will be described below. The person skilled in the art will recognize that the features described with reference to these specific embodiments may be modified and combined in different ways and that individual features may also be omitted. The general explanations in the sections above also apply to the more detailed explanations below.

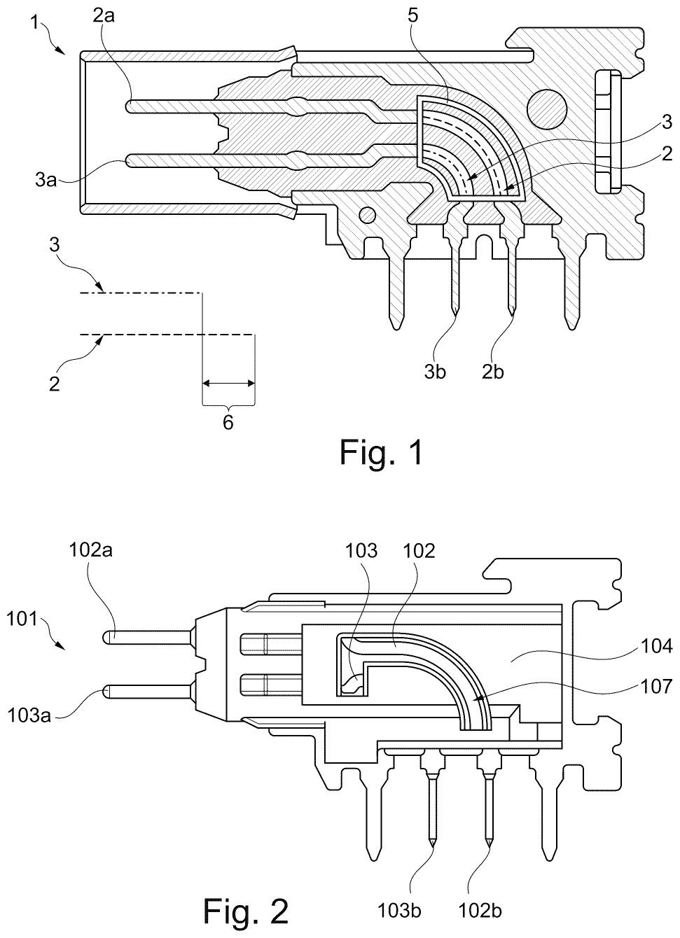

FIG. 1 illustrates skew caused in an electrical connector 1 by differences in length of two conductors 2, 3. The connector 1 is an insert molded lead frame assembly (IMLA). The conductors 2, 3 each include a first end 2a, 3a, respectively, which is arranged to come in electrical contact with a corresponding mating end of another connector or plug. The conductors 2, 3 each include a second end 2b, 3b, respectively, which form pins to be received by vias of a printed circuit board (PCB). Each of the conductors 2, 3 runs through a bent section 5, i.e., the conductors 2, 3 form a curve having 90°. As the conductors 2, 3 are vertically staggered, i.e., conductor 2 is arranged above conductor 3, both conductors have a different mechanical length. This is illustrated in the lower left corner of FIG. 1 which illustrates the resulting difference in length 6 between the first conductor 2 and the second conductor 3 due to the bent section 5.

Thus, the first conductor 2 is longer than the second conductor 3. This leads to a difference in propagation delay of electrical signals transmitted via the conductors 2, 3. For example, a signal fed to the first ends 2a, 3a of the conductors 2, 3 will first arrive at the second end 3b of the shorter conductor 3. Conversely, a signal fed to the second ends 2b, 3b of the conductors 2, 3 will first arrive at the first end 3a of the shorter conductor 3. If the conductors 2, 3 form a differential pair, this may lead to a shift from the differential mode to a common mode signal (so called mode conversion) which may contribute to jitter and can impair signal detection. In addition, electromagnetic compatibility (EMC) may be worsened. In case the two conductors 2, 3 form parallel lanes relative to a common reference potential such as ground, skew may lead to different signal arrival times and, thus, data transmission problems if the offset in signal arrival times cannot be properly compensated (e.g., by a buffer in the electronics). Therefore, the skew introduced by different mechanicals lengths of the conductors 2, 3 should be reduced as much as possible to avoid the detrimental effects mentioned.

FIG. 2 illustrates an embodiment of a connector 101 according to an embodiment that overcomes the disadvantages mentioned above. The connector 101 is an IMLA just like the example of FIG. 1 and includes a first conductor 102 and a second conductor 103. It should be noted that the present invention is not restricted to this type of connector but generally encompasses different types of electrical connectors. Also, the number of conductors may vary within the scope of the present invention.

The conductors 102, 103 each include a first end 102a, 103a, respectively, which is arranged to come into electrical contact with a corresponding mating end of another connector or plug. The conductors 102, 103 each include a second end 102b, 103b, respectively, which form pins to be received by vias of a printed circuit board (PCB). Similar to the example of FIG. 1, each of the conductors 102, 103 runs through a bent section (not highlighted in FIG. 2), i.e., the conductors 102, 103 form a curve having 90°. As the conductors 102, 103 are vertically staggered, i.e., conductor 102 is arranged above conductor 103, both conductors have a different mechanical length.

The conductors 102, 103 are embedded in an insulating element 104 which in the example of FIG. 1 is arranged between and around the conductors 102, 103. In other embodiments, the insulating element 104 may be arranged just between the conductors 102, 103 or just around the conductors. The insulating element 104 can be obtained by molding. Exemplary materials for the insulating element include polyphthalamide (PPA), liquid crystal polymers (LCP) and polybutylene terephthalate (PBT). Advantageously, the insulating element 104 is an overmold, i.e., the conductors 102, 103 are embedded in the insulating element 104 during molding. For example, the insulating element 104 can be formed by injection molding.

The insulating element 104 includes a recess 107 such that no material of the insulating element 104 is arranged over a portion of the longer conductor 102. A portion of the recess 107 is also arranged over a portion of the shorter conductor 103 but this portion is significantly smaller than the portion of the recess 107 over the longer conductor 102. Generally, the shorter conductor 103 might be exposed in the same way as the longer conductor 102 at sections where the conductors do not have a length difference for reasons of impedance and return loss optimization.

The recess 107 forms an air pocket and lowers the permittivity and/or permeability at the first conductor 102 compared to the second conductor 103. As propagation of an electromagnetic wave essentially occurs outside of a conductor, especially at high frequencies, the permittivity and permeability of the material proximal to the conductor directly influences the speed of propagation. The lower the permittivity and/or permeability of such a medium (or no medium at all in case of a vacuum), the higher the speed of signal propagation. Therefore, the recess 107 causes signals to propagate faster through the longer conductor 102 than through the shorter conductor 103. The recess 107 in the example of FIG. 2 is designed such that the different permittivity and/or permeability caused by the recess 107 compensates for the differences in length. Therefore, an electrical signal coupled into both conductors 102, 103 at the first ends 102a, 103a will arrive at the opposite ends 102b, 103b at the same time and vice versa. In this way, the different mechanical lengths of the conductors 102, 103 are compensated by the recess 7 in the insulating element 4.

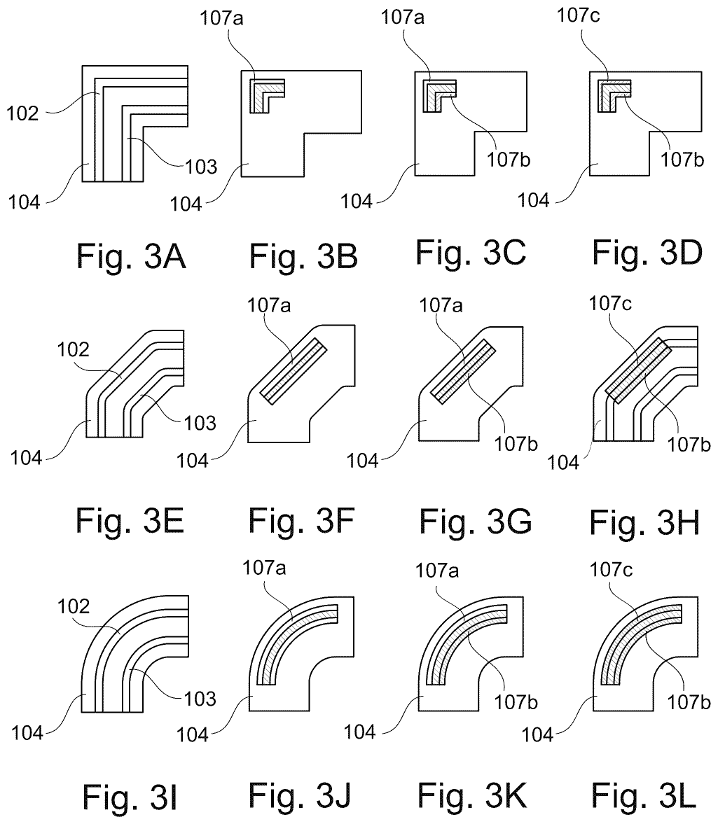

FIGS. 3A to 3L illustrates different possibilities of guiding two conductors 102, 103 in a 90° turn and different types of skew compensation according to some embodiments. In FIGS. 3A, 3E, and 3I, two conductors 102, 103 of a connector are illustrated, such as connector 101 as illustrated in FIG. 2. Each of the conductors 102, 103 has a bent section of 90°. In FIGS. 3A to 3D, the conductors 102, 103 make a sharp 90° turn, whereas in FIGS. 3E to 3H, both conductors have two 45° curves. In FIGS. 3I to 3L, both conductors 102, 103 follow a quarter of a circle.

In FIGS. 3B, 3F, and 3J, the insulating element 104 in which the conductors 102, 103 are embedded includes a recess 107a such that a portion of the underlying longer conductor 102 is exposed. The conductor 102 is still embedded in the insulating element 104 at the exposed portion which adds to the mechanical stability of the conductor. In FIGS. 3C, 3G, and 3K, the insulating element 104 additionally includes a slot 107b arranged at the side of the first conductor 102 facing the second conductor 103. In FIGS. 3D, 3H, and 3L, the insulating element 104 further additionally defines a slot 107c arranged at the opposing side of the first conductor 102. Thus, the permittivity and permeability at the longer conductor 102 decreases from left to right.

### LIST OF REFERENCE SIGNS

1 Electrical connector
2 Longer, first conductor
3 Shorter, second conductor
4 Insulating element
5 Bent section
6 Difference in length
7 Recess or slot
7a Recess
7b, 7c Slot
101 Electrical connector
102 Longer, first conductor
103 Shorter, second conductor
104 Insulating element
105 Bent section
106 Difference in length
107 Recess or slot
107a Recess
107b, 107c Slot

1. An electrical connector, comprising:
two or more electrical conductors, wherein the conductors are mutually electrically insulated and wherein a first one of the at two or more conductors is longer than a second one of the two or more conductors; and
at least one insulating element arranged between the first and the second conductor and/or around at least one of the first or the second conductor, wherein at least a portion of the insulating element causes a smaller permittivity and/or permeability for the first conductor and a higher permittivity and/or permeability for the second conductor and wherein a difference of permittivity and/or permeability between the first and second conductor is configured such that a difference in signal delay between the first and the second conductor is essentially minimized.

2. The electrical connector according to claim 1, wherein the first and second conductors are curved causing a difference in length between both conductors.

3. The electrical connector according to claim 1, wherein the insulating element comprises at least one air pocket causing lower permittivity and/or permeability for the first conductor.

4. The electrical connector according to claim 3, wherein the air pocket is a recess.

5. The electrical connector according to claim 3, wherein the air pocket is a slot.

6. The electrical connector according to claim 3, wherein the air pocket is arranged nearer to the first conductor than to the second conductor.

7. The electrical connector according to claim 3, wherein the air pocket is arranged such that a portion of a surface of the first conductor is exposed to air.

8. The electrical connector according to claim 1, wherein the insulating element comprises at least one additive causing the higher permittivity and/or permeability for the second conductor.

9. The electrical connector according to claim 8, wherein the additive is glass fibers.

10. The electrical connector according to claim 8, wherein the additive is ceramic.

11. The electrical connector according to claim 8, wherein the additive is pigments.

12. The electrical connector according to claim 8, wherein a density of the at least one additive is higher in a proximity to the second conductor compared to a proximity of the first conductor.

13. The electrical connector according to claim 1, wherein the connector is an insert molded lead frame assembly.

14. The electrical connector according to claim 1, wherein the first conductor and the second conductor form a differential pair.

15. The electrical connector according to claim 1, wherein the first conductor and the second conductor form parallel lanes.

16. The electrical connector according to claim 1, wherein the connector is a data connector adapted for data transmission.
